(19) United States
(12) Patent Application Publication
(10) Pub. No.: US 2009/0048025 A1
(43) Pub. Date: Feb. 19, 2009

(54) Method and apparatus for a rule development process for inducement prizes

(76) Inventor: J. Kent Pepper, New York, NY (US)

Correspondence Address: Bressler, Amery & Ross, P.C., 17 State Street, New York, NY, 10004, US

(21) Appl. No.: 11/893,891

(22) Filed: Aug. 17, 2007

(51) Int. Cl. G06F 17/00; G06Q 30/00

(52) U.S. Cl. 463/43; 705/1

(57) ABSTRACT

A method and apparatus for a rule development process for inducement prizes is presented. The rule development process comprises a number of sub-process threads allowing for the authoring, review, preview, approval and presentation of rules setting parameters for successful claiming of the inducement prize. The process also allows for sub-process threads for contributing to, submitting to, verification of, merger of, voting for, and revision of the inducement prize as well as the appointment of a prize administrator. The Inducement Prize Rule Development Process allows rules to be authored for the sake of creating a goal for claiming of a prize.

### FIELD OF THE INVENTION

The present invention relates generally to a method and apparatus for a rule development process for inducement prizes, and more particularly, to process threads for the authoring, editing, review and approval of inducement prize rules to establish parameters for the contribution to and claiming of the inducement prize.

### BACKGROUND OF THE INVENTION

Inducement prizes have long been offered by individuals and organizations to induce others to engage in the research and development of a particular goal. The goal is often a highly desirable discovery wanted by the scientific or medical communities or a long felt need of the manufacturing industries or military. Inducement prizes act as a catalyst for such research and development and thus are important for research and development in areas which might have otherwise gone un-researched or un-developed. In addition, they allow participation in the research and development process by individuals and organizations that might not otherwise be considered. In many instances the inducement prize spurs competition among such researchers as they hope to reap the awarding of the inducement prize. The inducement prizes themselves can take many forms, but are generally cash prizes.

Generally organizations, such as the federal government, establish an inducement prize for a particular research and development goal by creating the rules or parameters internally by which a participant could successfully claim the inducement prize. While they might seek expert advice and assistance from outside sources, it is the sole responsibility of the organization to identify and reconcile those sources. For instance, in 2004 NASA inaugurated the Centennial Challenges for seven contests having inducement prize purses ranging from $200,000 for design of a new astronaut's glove to $2 million for creation of a new lunar lander. While the Centennial Challenges fall within the organization's immediate area of expertise, NASA had to rely on its own known resources in developing the rules for the prize and, had they chosen to pursue an objective outside their purview, would have faced considerable obstacles to acquiring the knowledge required to draft an appropriate set of rules.

Additionally, while there are means by which contributions may be made to academic papers by disparate individuals, these means do not translate into establishing an inducement prize. For instance, the on-line collaborative encyclopedia “Wikipedia” has a process by which individuals may contribute to articles stored in the database and displayed by user recall. The process depends on a developed body of policies and guidelines directed towards the goal of creating the encyclopedia that all contributors are expected to follow and that can be can be summarized as five pillars that define Wikipedia's character. Each contribution creates a new version of the article and, while all prior versions of articles are stored, it is the latest version of the article that is presented by user recall. Thus anyone can edit any unprotected page at any time and save those changes immediately to that page. While an article may be temporarily locked to prevent reoccurring vandalism, there is no means by which to declare a particular revision of the article the definitive version and prevent additional alterations.

Thus it can be seen that heretofore there has been no designed methodology or apparatus by which rules can be efficiently and collaboratively established to lay out the parameters for the successful claiming of an inducement prize.

### SUMMARY OF THE INVENTION

Accordingly, the present invention is directed to allow for an individual or organization to establish parameters for the claiming and awarding of a prize inducing specific work designed to reach an outcome set by the rules parameters. To allow the individual or corporation to set the parameters, the present invention discloses a rule development process comprising of several sub-process threads and decision tress.

The sub-process threads include an Authoring Process, a Review Process, a Preview Process, an Approval Process and a Presentation Process. The Authoring Process is the sub-process thread by which the original author of the inducement prize creates and submits a first draft of requirements of the rules for the claiming and awarding of the proposed inducement prize. The Review Process is the sub-process thread which allows a third party (i.e., a member of the public) to edit/revise the requirements of the rules for claiming and awarding of the prize. The Review Process thereby allows for collaborative improvement of the set of rules. The Preview Process is the sub-process thread which allows for potential participants for the contribution to and claiming of the inducement prize to Preview the most recent version of the rules until such time as the rules are finalized. The Approval Process is the sub-process thread by which the original author reviews the community edits and may approve if so desired. The Presentation Process is the sub-thread process by which users of the website can view the rules of the prize after they have been finalized.

The rule development process for the inducement prize also comprises a number of additional sub-process threads, in addition to those mentioned above. The additional sub-process threads include a Contribution Process, a Submission Process, a Verification Process, a Merger Process, a Revision Process, and a Voting Process.

The Contribution Process is the sub-process thread by which monetary (or otherwise) contributions may be made to the inducement prize. The Submission Process is the sub-process thread allowing for claiming of the inducement prize. The Verification Process is the sub-process thread by which contributors to the inducement prize determine whether the inducement prize claimant's submission fulfills the requirements of the rules. The Merger Process is the sub-process thread by which a merger of two separate inducement prizes into one combined inducement prize may be accomplished. The Revision Process is the sub-process thread by which a revision of an inducement prizes may be conducted. The Voting Process is the final sub-process thread allowing for such Merger Process and Revision Process to be voted upon and either accepted or rejected by the contributors.

The present invention, including its features and advantages, will become more apparent from the following detailed description with reference to the accompanying drawings.

### BRIEF DESCRIPTION OF THE DRAWINGS

FIG. 1 illustrates a flow chart of a methodology for implementation of the rule development process for inducement prizes, according to an embodiment of the present invention.

FIG. 2 illustrates a flow chart of a thread of the methodology for an Authoring process, according to an embodiment of the present invention.

FIG. 3 illustrates a flow chart of a thread of the methodology for a Review Process, according to an embodiment of the present invention.

FIG. 4 illustrates a flow chart of a thread of the methodology for a Preview Process, according to an embodiment of the present invention.

FIG. 5 illustrates a flow chart of a thread of the methodology for an Approval Process, according to an embodiment of the present invention.

FIG. 6 illustrates a flow chart of a thread of the methodology for a Presentation Process, according to an embodiment of the present invention.

FIG. 7 illustrates a flow chart of a thread of the methodology for a Contribution Process, according to an embodiment of the present invention.

FIG. 8 illustrates a flow chart of a thread of the methodology for a Submission Process, according to an embodiment of the present invention.

FIG. 9 illustrates a flow chart of a thread of the methodology for Verification Process, according to an embodiment of the present invention.

FIG. 10 illustrates a flow chart of a thread of the methodology for a Merger Process, according to an embodiment of the present invention.

FIG. 11 illustrates a flow chart of a thread of the methodology for a Voting Process, according to an embodiment of the present invention.

FIG. 12 illustrates a flow chart of a thread of the methodology for a Revision Process, according to an embodiment of the present invention.

FIG. 13 illustrates a flow chart of a thread of the methodology for an Administrator Appointment Process, according to an embodiment of the present invention.

FIG. 14 illustrates an apparatus for implementation of the rule development process for inducement prizes, according to an embodiment of the present invention.

### DETAILED DESCRIPTION

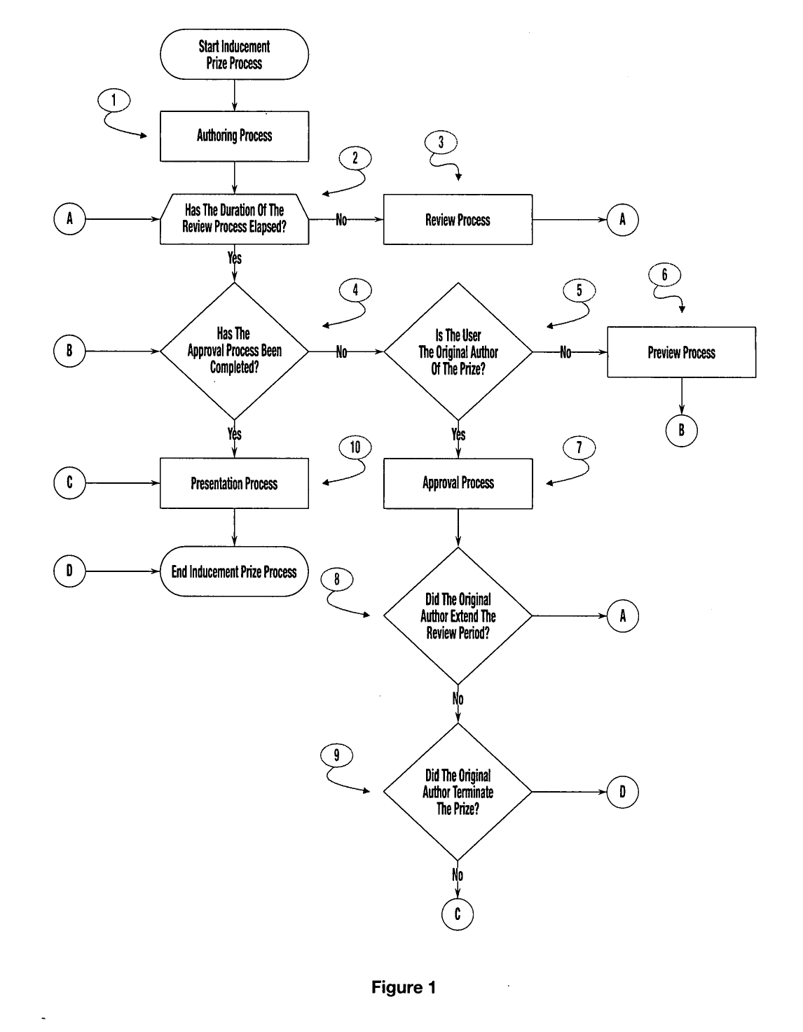

FIG. 1 through FIG. 14 illustrate a method and apparatus for an inducement prize rule development process by which an original author may create rules to set parameters and/or guidelines by which an inducement prize may be claimed. Such method and apparatus allows for the authoring, review, preview, approval, and presentation of the rules, and allows for contributions to the inducement prize, the claiming of the inducement prize, verification that the parameters and/or guidelines have actually been met by the prize claimant, the merger of two or more inducement prizes, the revision of the rules, voting as to whether the merger and/or revision is acceptable to prize contributors, and appointment of a new prize administrator.

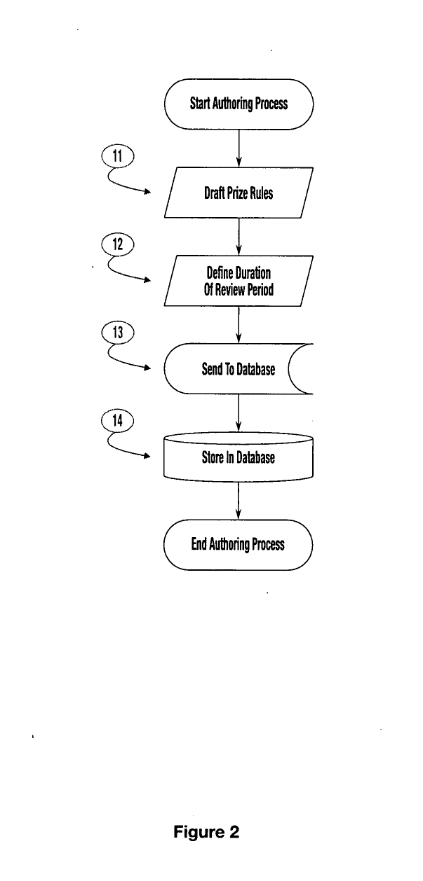

Referring now specifically to FIG. 1, the logic flow for an overall methodology for the Authoring Process, Review Process, Preview Process, Approval Process, and Presentation Process for an inducement prize is shown. As such, step 1 of the Inducement Prize Rule Development Process is the implementation of the thread of the Authoring Process. The Authoring Process 1 is a process wherein the creator of the prize authors and submits a first draft of the rules for the proposed inducement prize. The steps for the Authoring Process 1 are described in greater detail below with specific reference to FIG. 2.

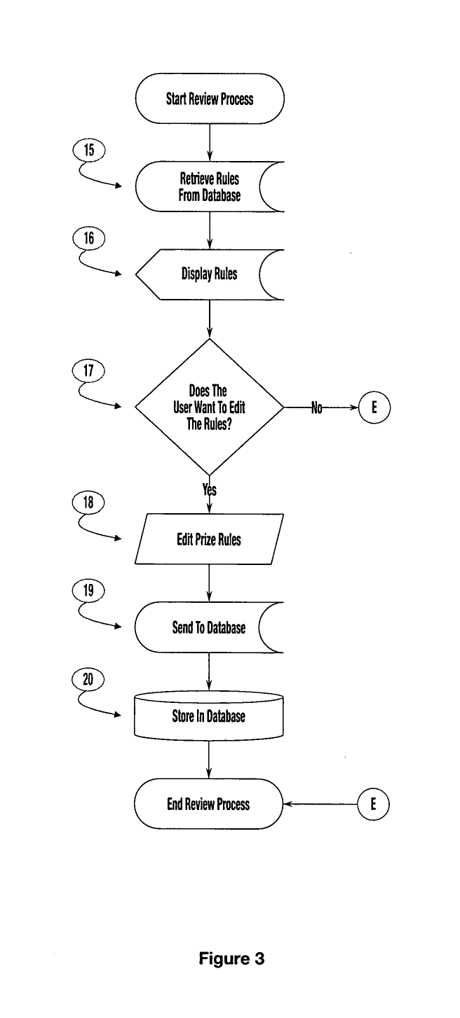

The Inducement Prize Rule Development Process continues in step 2 with a decision tree for whether the duration of the Review Process has elapsed. During the Authoring Process 1 the original author will define how long the draft rules of the prize will be open for revision by third parties. If such duration has not elapsed, implementation of the sub-process thread of step 3, the Review Process, begins. The Review Process 3 is described in greater detail below with specific reference to FIG. 3. The Review Process allows the third parties to visit the website and allows for them to make edits to the rules of the prize in order to improve such rules.

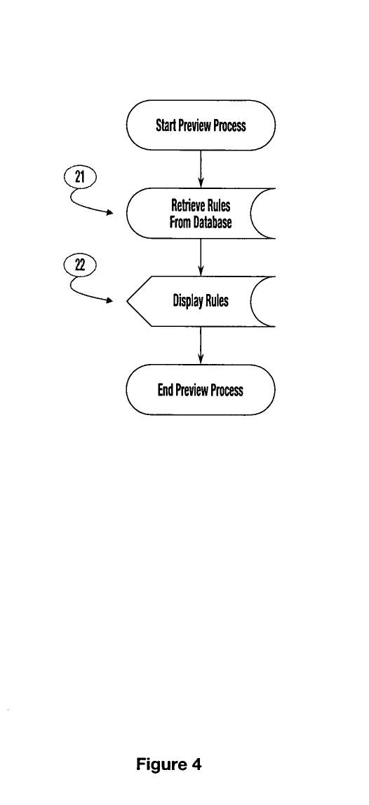

Further referring to FIG. 1, if in step 2 the duration of the Review Process has elapsed, but as determined in step 4 the original author has not yet chosen to finalize the rules as accomplished in step 7, then, provided in step 5 that the visitor to the website is not the original author of the rules, in step 6 the Preview Process begins. The Preview Process 6 is described in greater detail below with specific reference to FIG. 4. The Preview Process 6 allows visitors to the website to see (i.e., preview) the most recent version of the rules until the original author finalizes them and makes the prize available for contributions.

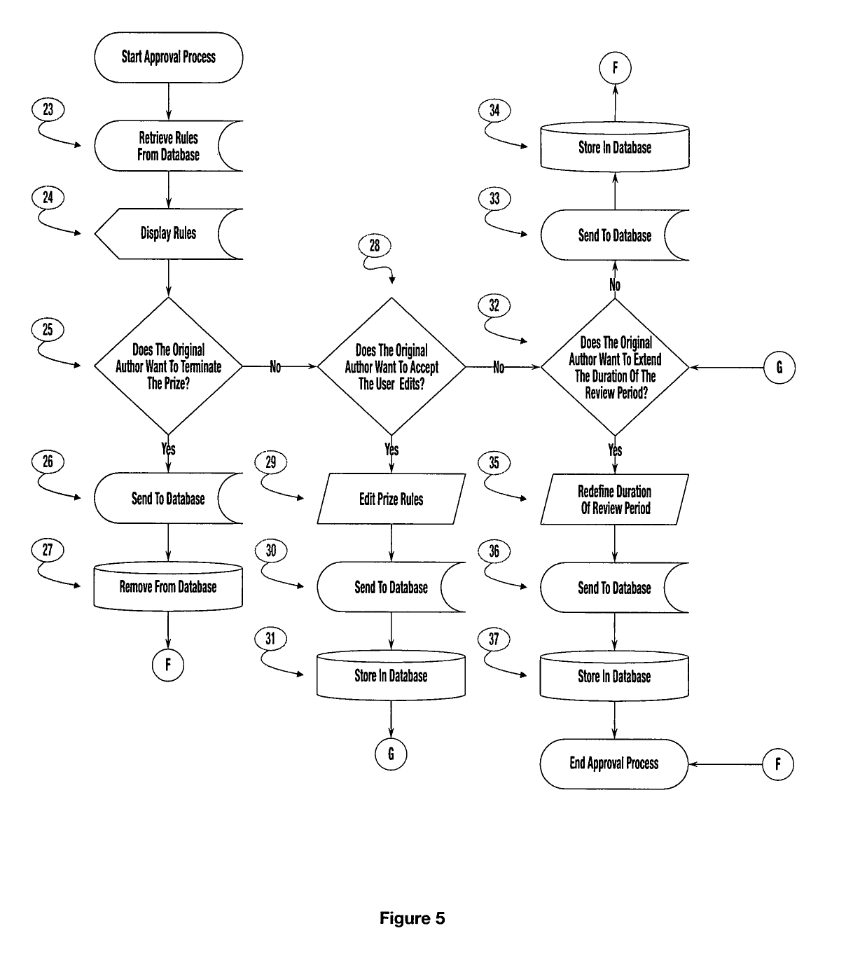

If in step 5 the visitor to the website is the original author of the draft prize rules, instead of proceeding to the Preview Process in step 6, the original author will begin the Approval Process in step 7. The Approval Process 7 is described in greater detail below with specific reference to FIG. 5. The Approval Process 7, which is only available to the original author of the draft set of rules, allows the original author of the inducement prize to review the community edits entered during the Review Process 3 and choose to accept them as is, make additional edits, extend the duration of the review period (per the decision tree in step 8) or terminate the prize (per the decision tree in step 9). If the original author chooses to extend the duration of the Review Process 3, the Review Process in step 3 is begun again until such point that the length of time specified by the original author in Approval Process 7 for the extended review elapses (per the decision tree in step 2). If, per the decision tree in step 9, the original author had opted to terminate the prize, the inducement prize development process is ended and no further action is taken or required.

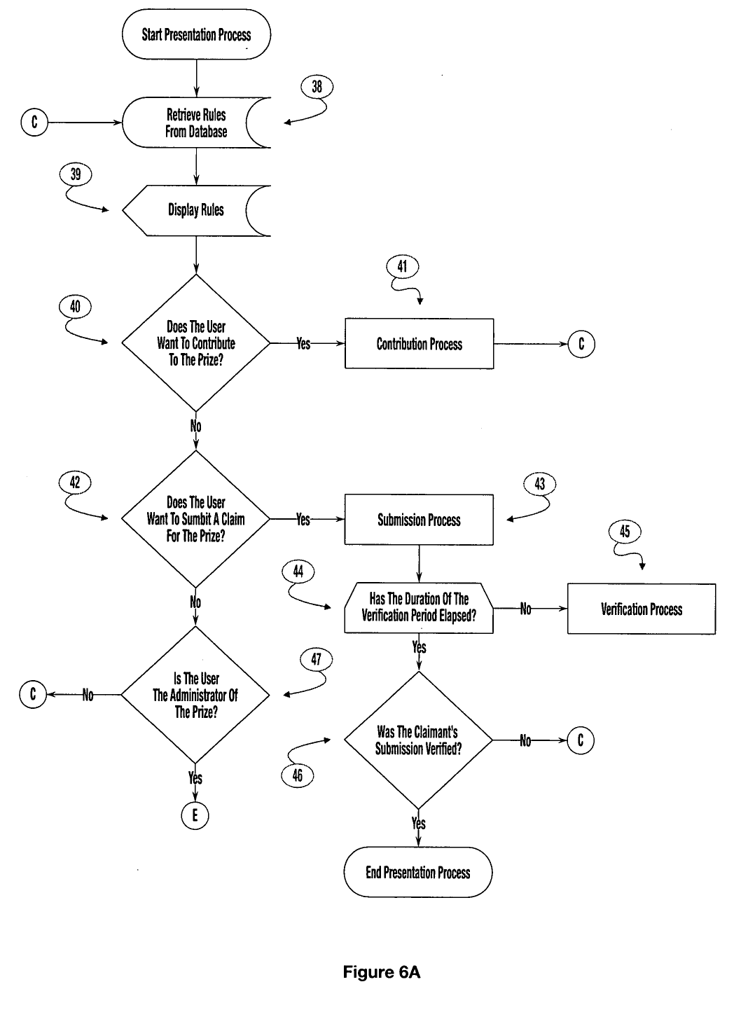

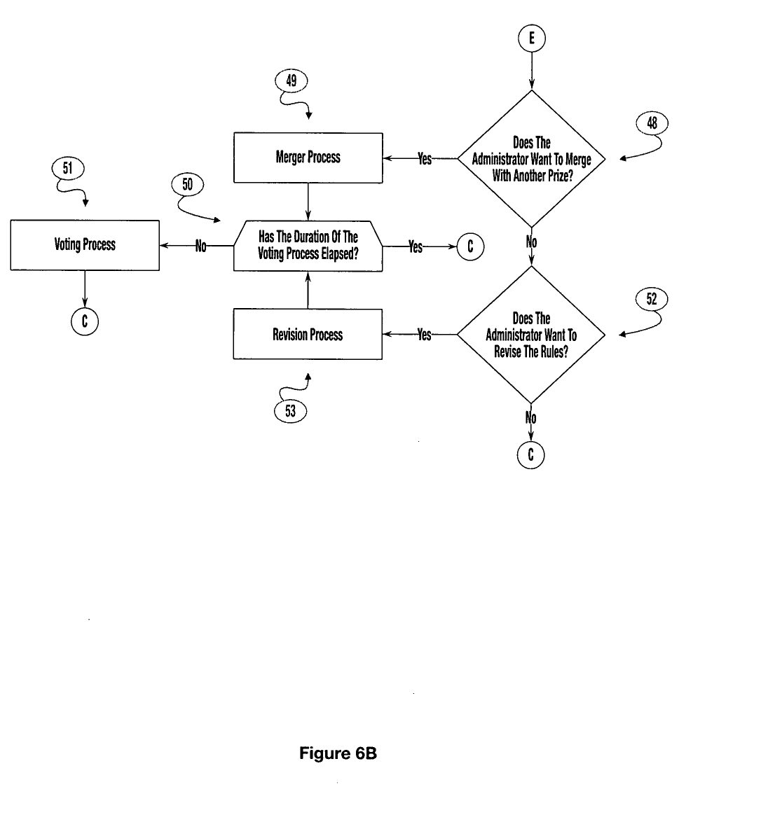

Referring yet further to FIG. 1, after the thread of the Approval Process in step 7 ends, if the original author has decided not to extend the duration of the Review Process 3 or terminate the prize, the thread of the Presentation Process in step 10 begins. The Presentation Process 10 is described in greater detail below with specific reference to FIG. 6. Once step 7 has been completed and the prize finalized, all users of the website will initially be presented with the Presentation Process 10. The Presentation Process 10 allows visitors to the website to see the finalized version of the rules in order to allow the user the opportunity to decide whether to make a contribution to the prize or submit a claim for the prize. The Presentation Process 10 allows the original author, once the Approval Process 7 has ended and the rules of the prize can no longer be edited (except in special circumstances outlined below), to open the inducement prize to receive contributions and submissions from users.

Referring now specifically to FIG. 2, the sub-process thread of the Authoring Process 1 is described. As mentioned above, the Authoring Process 1 is the sub-process thread wherein the original author of a prize authors and submits the first draft of the rules for the proposed inducement prize. Accordingly, in step 11 the original author drafts the rules of the prize. Such drafting may occur by choosing from a series of pre-defined options, authoring unique prize specific requirements, or from a combination of both.

In step 12 the original author determines the duration of the Review Process 3 during which the prize rules will be open for review and editing by other visitors to the site. In step 13 the rules drafted by the original author are sent to the database 123, and in step 14 the rules are stored in the database 123. This ends the Authoring Process 1.

As described above with regard to FIG. 1, if the duration of the Review Process has not elapsed, in step 3 the thread of the Review Process begins. Accordingly, referring now specifically to FIG. 3, the Review Process 3 is described. The Review Process 3 allows a third party visitor to the website to make edits to the rules of the prize. The Review Process 3 begins in step 15 with a retrieval of the stored rules from the database 123. In step 16 the rules are displayed on the screen of the user's computer 112, and in step 17 the user is given the option to edit the rules. If the user does not wish to edit the rules the process ends. However, if in step 17 the user wishes to edit the rules, then in step 18 the ability to make edits to the rules is presented to the user. Upon completion of such editing, in step 19 the edited rules are sent back to the database 123, and in step 20 the rules are stored in the database 123. This ends the Review Process 3.

As described above with regard to FIG. 1, if it has been determined in the decision tree of step 2 that the duration of the Review Process 3 has elapsed (i.e., the Review Process 3 has been completed), if it has been determined in the decision tree of step 4 that the original author has not yet finalized the rules, and if in the decision tree of step 5 it is determined that the visitor is not the original author, in step 6 the thread of the Preview Process begins.

Referring now specifically to FIG. 4, the Preview Process 6 allows visitors to the site to see a preview of the most recent version of the rules until such time as the original author finalizes them and makes the prize available for contributions. Accordingly, the thread of the Preview Process 6 begins in step 21 with a retrieval of the most recent edit of the rules from the database. In step 22 the most recent edit of the rules is displayed on the screen of the visitor's computer 1 12. After the rules are displayed the Preview Process 6 ends.

As described above with regard to FIG. 1, if in step 5 it is determined that the user is the original author, the overall Inducement Prize Rule Development Process continues in step 7 with the sub-process thread of the Approval Process. The Approval Process 7 allows the original author of the prize to review the collaborative edits, choose to accept them as is, make additional edits, extend the duration of the review period or terminate the prize.

Referring now specifically to FIG. 5, the thread of the Approval Process 7 begins in step 23 with a retrieval of the edited rules from the database 123. In step 24 the edited rules are displayed on the screen of the original author's computer 111.

In step 25 the original author is given the option of terminating the prize. If the original author decides to terminate the prize, in step 26 the information is sent to the database 123 and in step 27 the rules are removed from the database 123. This then ends the Approval Process 7 and in step 9, the Inducement Prize Process is ended.

In step 28, the original author is given the option to accept the users' edits to the inducement prize. If the original author decides to not to accept the users' edits made during the Review Process 3, then in step 29 the original author is given the ability to make further refinements to the rules. Upon completion of such editing, in step 30 the edited rules are sent back to the database 123, and in step 31 the rules are stored in the database 123.

Step 32 offers the original author the option to extend the Review Process 3. If the original author chooses not to extend the Review Process 3, in step 33 the rules are sent back to the database 123, and in step 34 the rules are stored in the database 123. This then ends the Approval Process 7. However, if the original author does decide to extend the Review Process 3, the original author sets the duration of the new period in step 35. The new duration of the review period is sent to the database 123 in step 36, and in step 37 the rules are stored in the database 123. Step 8 reinitiates the Review Process 3. This then also ends the Approval Process 7.

As described above with regard to FIG. 1, if in step 9 the original author has not chosen to terminate the prize or, in step 8, to extend the Review Process 3, the Presentation Process 10 is started. The Presentation Process 10 is described in greater detail in FIG. 6.

Referring now specifically to FIG. 6, the logic flow for the Presentation Process 10, which includes the sub-threads for the Contribution Process, Submission Process, Verification Process, Merger Process, Revision Process, and Voting Process for an inducement prize, is shown.

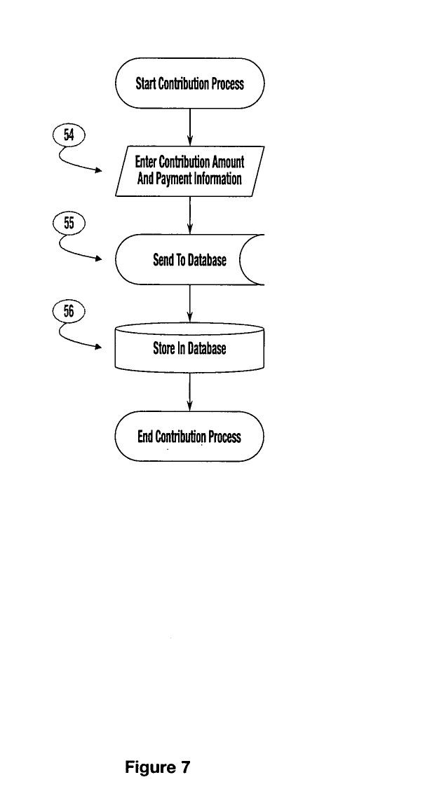

The thread of the Presentation Process 10 begins in step 38 with a retrieval of the rules from the database 123, and in step 39 the rules are displayed on the screen of the user's computer 111 112. The process continues with step 40 where the user is given the option to contribute to the prize. If the user chooses to make a contribution, the thread of the Contribution Process 41 is initiated. The Contribution Process 41 is described in greater detail in FIG. 7.

Referring now specifically to FIG. 7, the Contribution Process 41 begins. In step 54, the user enters the contribution amount and payment information. The contribution, which may be financial or other form that increases the value of the prize, is added to the total value of the prize. In step 55 the information is then sent to the database and in step 56 the information is stored into database 123. This ends the Contribution Process thread of the step 41.

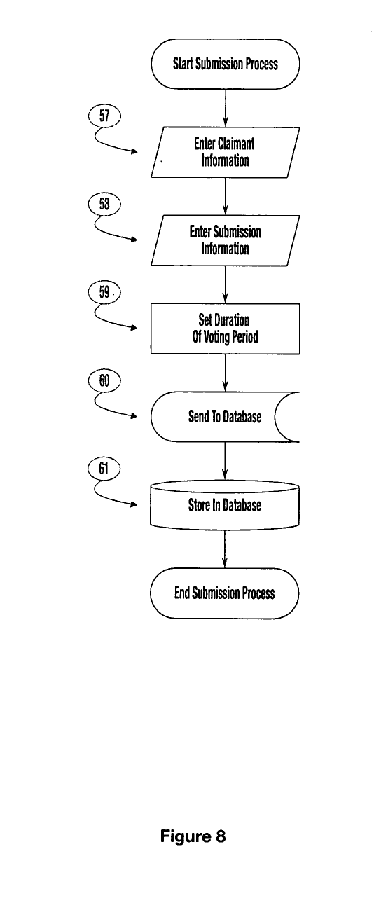

Referring now back to FIG. 6, in step 42, the user is given the option to submit a claim for the prize. If the user chooses to submit a claim, the Submission Process begins in step 43. The Submission Process 43 allows anyone who can demonstrate that they performed the action required to meet the rules of the inducement prize the ability to submit their proof to claim the prize. The thread of the Submission Process of step 43 is described in further detail below with reference to FIG. 8.

Referring now specifically to FIG. 8, the thread of the Submission Process of step 43 begins. In step 57 the claimant enters their contact information. In step 58 the claimant submits any information required to verify that the claimant's action satisfies the rules. In step 59 the duration of the verification period for the Submission Process 14 is determined. In step 60 the submission is sent to the database 123, and in step 61 the submission is stored in the database 123. This then ends the Submission Process of step 43.

Referring now back to FIG. 6, in step 44 it is determined whether the duration of the Verification Process 45 of the Submission Process 43 has elapsed. Contributors have a specified period of time, based on predefined criteria, to complete the Verification Process 45.

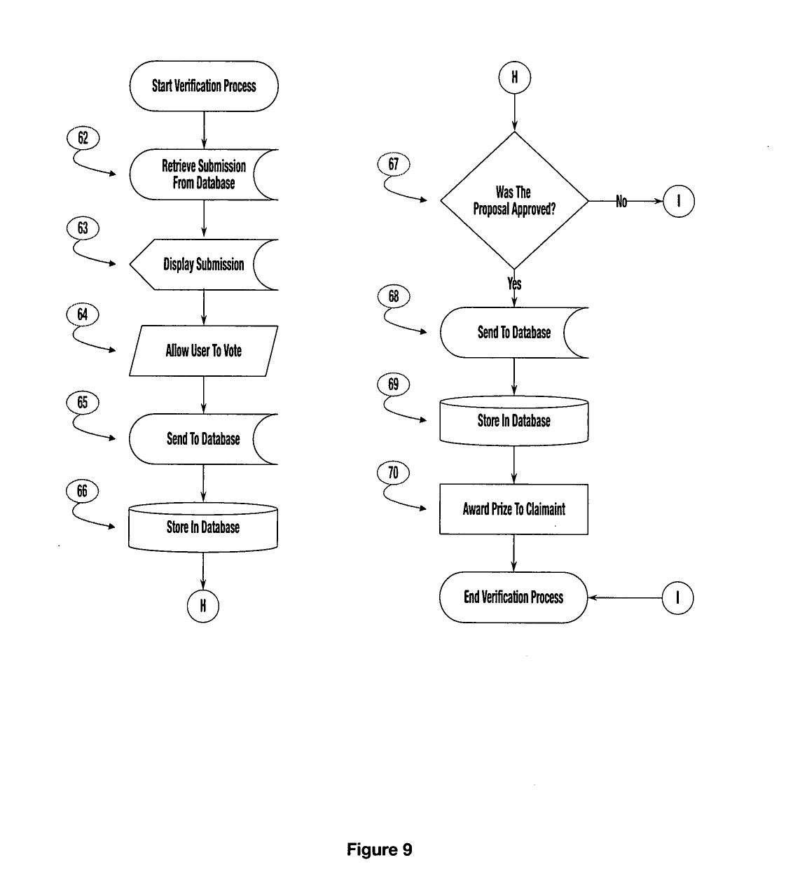

If it is determined that the duration of the verification period has not elapsed then the thread of the Verification Process of step 45 begins. The Verification Process 45 is described in greater detail in FIG. 9.

Referring now specifically to FIG. 9, the Verification Process of step 45 begins. In step 62 the submission of the claimant is retrieved from the database 123, and in step 63 the submission is displayed on the screen of the user's computer 111 112. In step 64 the contributor is given the ability to vote for or against the approval of the submission. In step 65 the results of the votes are sent to the database 123, and in step 66 they are stored in the database 123. In step 67, it is determined whether the proposal has been approved. If the duration of the Verification Process 45 has elapsed and it is determined that the proposal was not approved then the Verification Process of step 45 ends. Otherwise, if the proposal is approved after the duration of the Verification Process 45 has elapsed then in step 68 verification of the submission is sent to the database 123, and in step 69 the verification is stored in the database. In step 70 the prize is awarded to the claimant and the inducement prize is closed. This then ends the Verification Process of step 45.

Referring now back to FIG. 6, in step 46, if the duration of the Verification Process 45 has elapsed, then in step 46 it is determined whether the claimant's submission was verified. If the claimant's submission was not verified then the Presentation Process of step 10 begins anew. If the claimant's submission is verified and the prize has been paid, the Presentation Process ends, and the inducement prize development process is ended and no further action is taken or required.

In step 47, if the visitor is the administrator 111 of the prize, additional administration options will be offered. The administer of the prize is typically the original author of the prize, but there may be occasions where a third party is named administrator. If in step 47 the visitor is not the administrator, then the Presentation Process 10 begins anew.

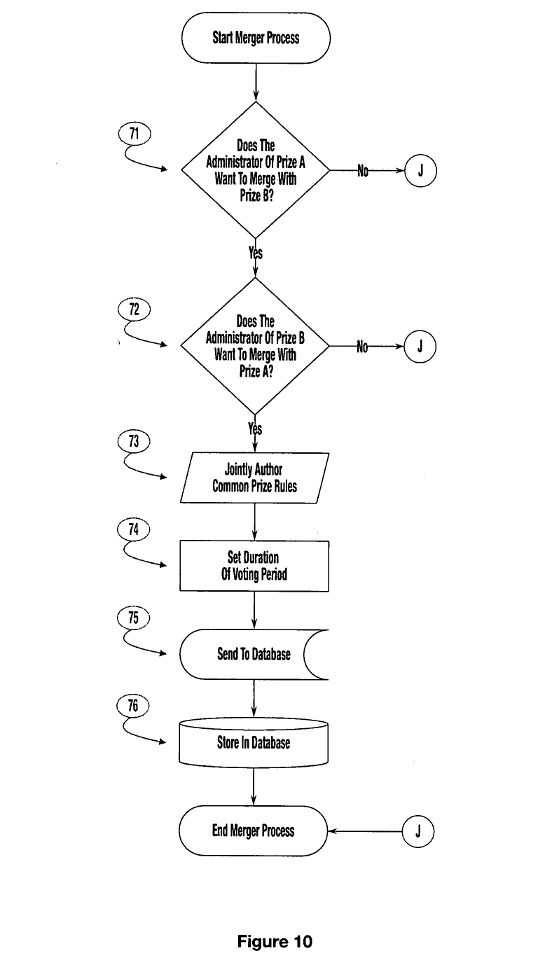

Referring further to FIG. 6, in step 48 if there are two prizes with similar objectives, the individual administrators of the inducement prizes may decide to merge the prizes into one with a common set of rules. If in step 48 the administrators decide to merge the two separate inducement prizes into one, then in step 49 the thread of the Merger Process begins. The Merger Process 49 allows the administrators of the two prizes to merge their respective prizes and author a common set of rules. Based on pre-defined criteria, the duration of the contributor Voting Process 51 will be determined. The Merger Process 49 is described in greater detail below in FIG. 10.

Referring now specifically to FIG. 10, the thread of the Merger Process 49 begins. In step 71 the administrator of a prize determines whether to merge with another prize. If the administrator of first prize, prize A, does not agree to merge with the second prize, prize B, then the Merger Process 49 ends. However, if in step 71 the administrator of prize A agrees to merge with prize B, in step 72 the administrator of prize B is given the option of whether to merge with the prize A. If the administrator of prize B decides not to agree to merge then the thread of the Merger Process 49 ends. However, if the administrator of prize B does decide to merge with prize A, then in step 73 the two administrators co-author a set of mutually agreed upon rules. In step 74 the duration of the Voting Process 51 for the proposed mergers determined. In step 75 the proposed merged rules are sent to the database 123 and in step 76 the proposed merged rules are stored in the database 123. This then ends the Merger Process 49.

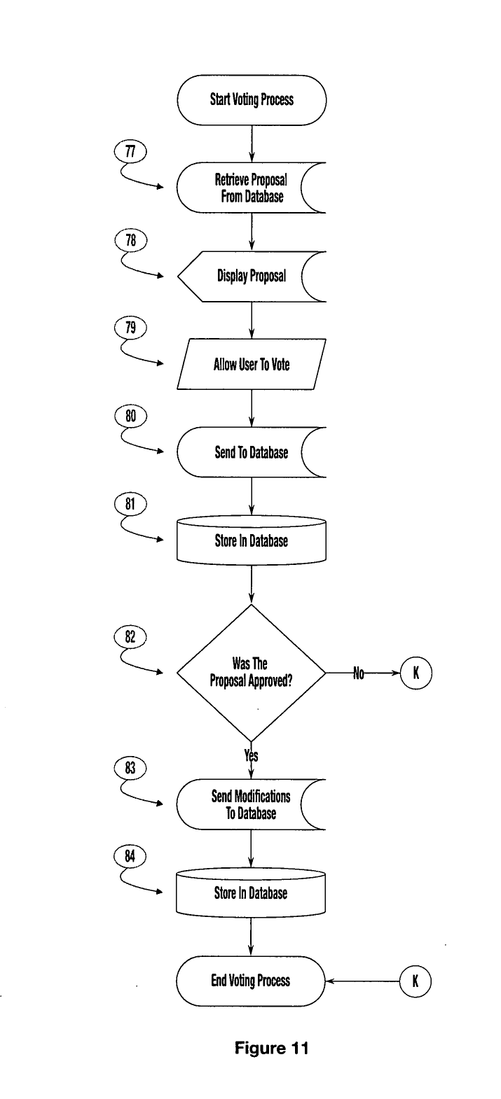

Referring now back to FIG. 6, in step 50 it is determined whether the duration of the Voting Process 51 has elapsed. If the duration of the Voting Process 51 has elapsed then the thread of the Presentation Process 10 begins anew. If, however, in step 50 it is determined that the Voting Process 51 has not elapsed, then the thread of the Voting Process 51 begins. In the Voting Process 22, every contributor will have one vote to cast for or against the proposal under consideration. The Voting Process 51 is described below in greater detail with reference to FIG. 11. If the proposal receives the requisite number of votes, it will pass and the appropriate action will be taken. If the proposal does not receive the requisite number of votes, the proposal will fail and no further action will be taken.

Referring now specifically to FIG. 11, the thread of the Voting Process 51 begins. The proposal is retrieved from the database 123 in step 77, and in step 78, the proposal is displayed on the user's computer 111 112. In step 79 the contributor is given the ability to vote for or against the proposal. In step 80 the results of the vote are sent to the database 123 and in step 81 the results are stored in the database 123. When the duration of the Voting Process has elapsed, in step 82 the vote is tallied. If the proposal was not approved, the thread of the Voting Process 51 ends. If in step 82 the proposal was approved, then in step 83 the modifications are sent to the database 123 and in step 84 the modifications are stored in the database 123. This then ends the thread of the Voting Process 51.

Referring now back to FIG. 6, upon completion of the thread of the Voting Process in step 51, the thread of the Presentation Process in step 10 is begun anew. Likewise if in step 50 the duration of the Voting Process has elapsed the thread of the Presentation Process in step 10 begins anew.

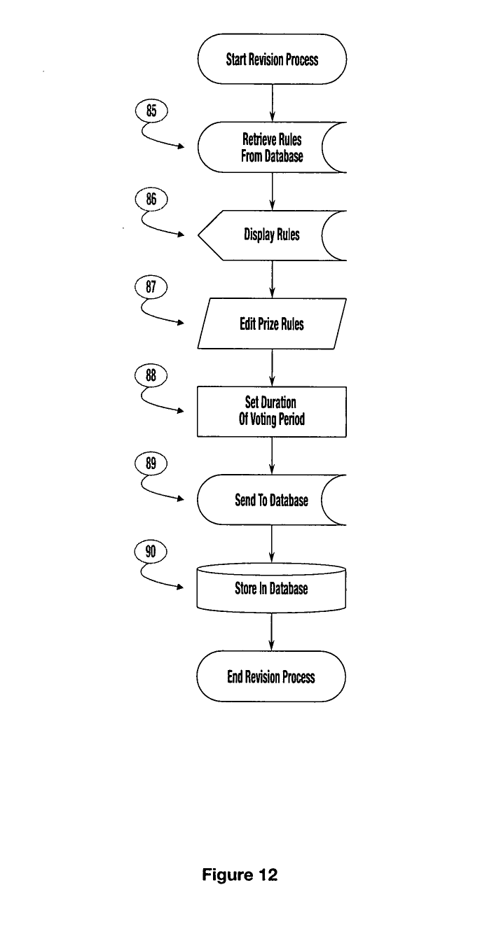

Returning to step 48, if the administrator does not wish to merge the two prizes then in step 52 the administrator is given the choice to revise the rules. Such occurs if, during the course of the executing of the rules for the inducement prize, it is determined that the rules are inadequate, the administrator has the option to make revisions pending the approval of the contributors. Accordingly, if such rules are to be revised then the thread of the Revision Process in step 53 begins. The Revision Process 53 allows the prize administrator to be able to draft a revised set of rules for the contributors to vote on using the thread of the Voting Process in step 51. Based on predefined criteria, the duration of the contributor Voting Process will be determined. The Revision Process 53 is disclosed in greater detail below with reference to FIG. 12.

Referring now to FIG. 12 the thread of the Revision Process in step 53 begins in step 85 with a retrieval of the rules from the database 123. In step 86 the rules are displayed on the screen of the administrator's computer 111. In step 87 the administrator of the prize drafts a revised set of rules. In step 88 the duration of the Voting Process 51 for the proposed revision is determined. In step 89 the proposed rules are then sent to the database 123 and in step 90 the proposed rules are stored in the database 123. This then ends the thread of the Revision Process of step 53. Once again in step 50 it is determined whether the duration of the Voting Process 53 has elapsed. At this point a repeat of the thread of the Voting Process in step 51 as described above occurs if the duration of the Voting Process 51 of the voting period has not elapsed. If the duration of the Voting Process 51 has elapsed or if the thread of the Voting Process in step 51 has ended then the thread of the Presentation Process in step 10 may begin anew.

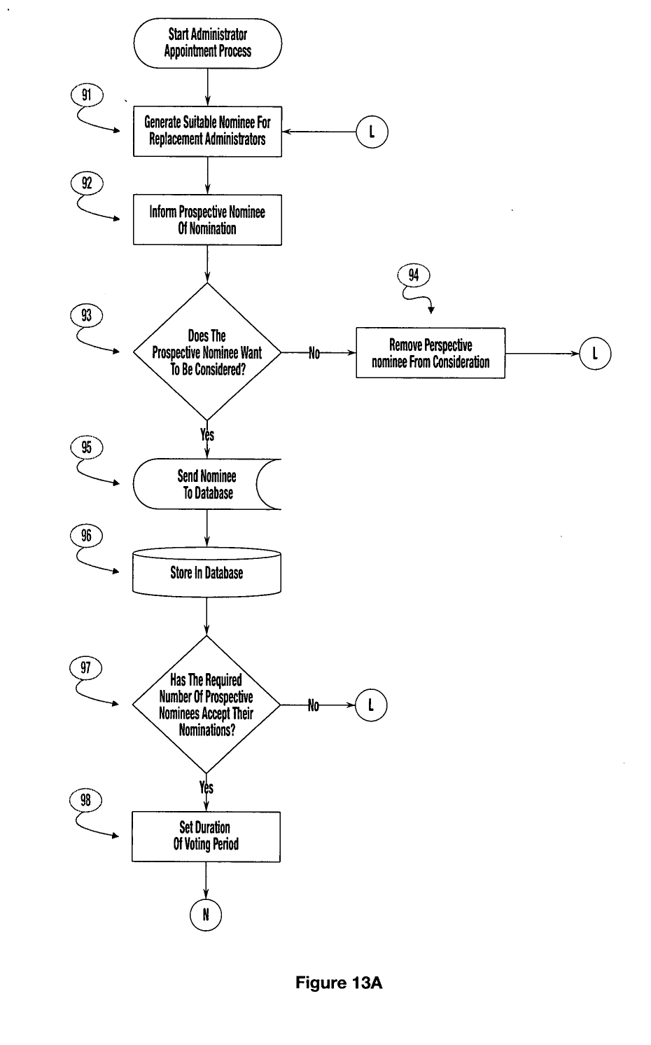

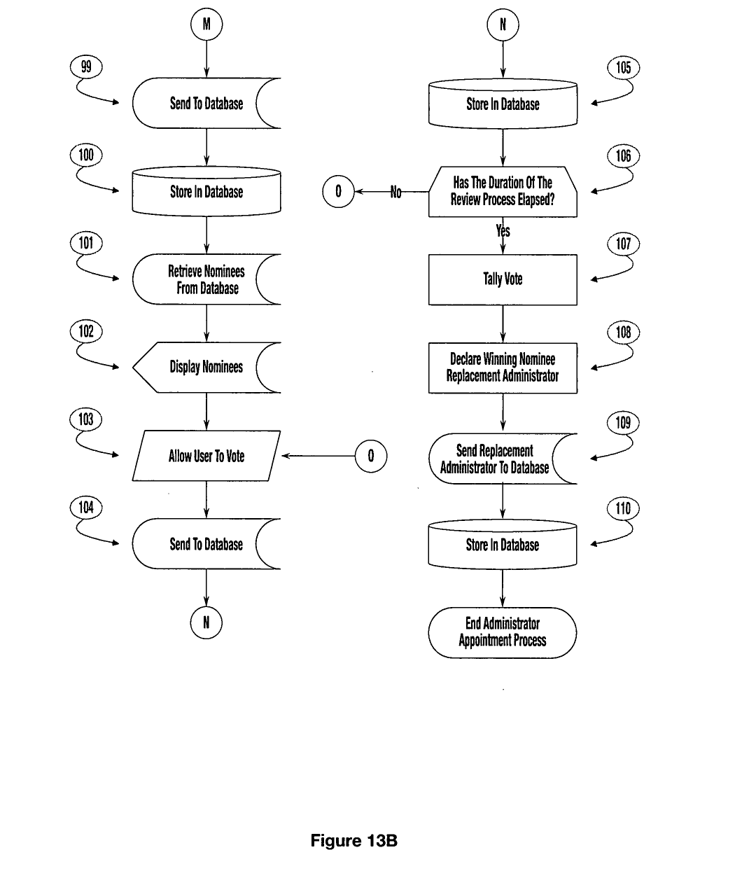

Referring now specifically to FIG. 13, the process for appointing a new administrator. If in the course of executing a prize, it is determined that a different administrator should be appointed, the Administrator Appointment Process will be initiated, and contributors will be able to vote for a new administrator from a list of nominees. Based on a list of suitable nominees, in step 91, a replacement nominee will be selected. In step 92, the prospective nominee will be notified and in step 93 given the option to accept or reject the nomination. If in step 93, the prospective nominee declines the nomination, then in step 94, the nominee's name is removed from consideration and step 91 is repeated. If the prospective nominee accepts the nomination in step 93, then in step 95, the nominee is then sent to the database 123 and in step 96 the nominee is stored in the database 123. In step 97, it is determined whether the required number of nominees have accepted the nomination. If the required number have not accepted, then step 91 is repeated until the required number of nominees have accepted their nominations. In step 98, the duration of the voting period is determined. In step 99, the duration of the voting period is then sent to the database 123, and in step 100, the duration of the voting period is stored in the database 123. In voting period begins in step 101 with the retrieval of the nominees from the database 123 and in step 102, the nominees are displayed on the screen of the user's computer 111 112. Contributors submit their vote for their preferred nominee in step 103. In step 104, the votes are sent to the database 123, and in step 105, the proposed rules are stored in the database 123. In step 106, it is determined whether the duration of the voting period has elapsed, and if it has not, the voting period continues. Once the duration of the voting period has elapsed, in step 107, the vote is tallied and the winning nominee declared in step 108. In step 109 the newly appointed administrator is then sent to the database 123, and in step 110, the appointed administrator is stored in the database 123. This ends the Administer Appointment Process.

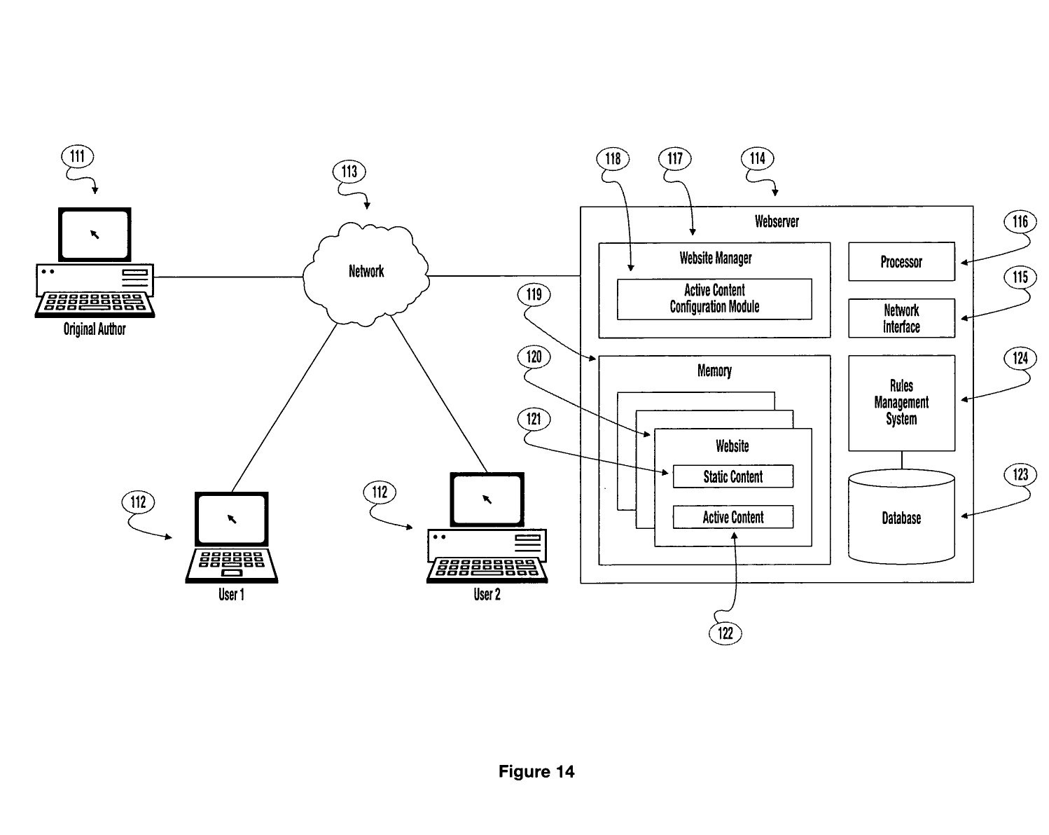

Referring now specifically to FIG. 14, an apparatus for the implementation of the inducement prize offering process is shown. Therein, an original author's network enabled computer 111 is connected through a network 113, such as the internet, to a web server 114. Likewise, a visitor's networked computer 112 is also connected through the network 113 to the web server 114.

Web server 114 contains the hardware and software for delivering web pages and content to the original author or visitor over the network 113. For instance, a network interface 115 and a microprocessor 116 through a website manager 117 processes operations relating to the downloading of the website page 120 with static un-editable content 121 and editable active content 122. Active content includes the rules of the inducement prize that may be edited, while the static content is content that, except upon initial authoring, remains unchanged.

The website manager 117 includes a tool referred to as an active content configuration module 118 to enable editing of the active content. If desired, the website manger 117 can be used to authorize user login to the web server 114 to allow for viewing and modifying of the active content 122 if the user 112 has permission. The active content configuration module 118 can then govern which users 112 have permission to edit the rules and control how the website 120 is ultimately rendered and viewed by viewers 112.

A rules management system 124 then keeps track of the changes to the rules of the inducement prize by versioning changes made to the web page within a memory 119 and stores such versions to a data base 123.

An Example of the Implementation of the Process

It is well know that potato chips begin to go stale quickly once the bag they're packaged in is opened. An individual interested in the development of a self-contained method for keeping potato chips fresh after the bag has been opened might choose to create an inducement prize to advocate for the development of the appropriate technology.

Using a computer 111 with access to the internet 113, the individual will visit a website 114 employing the process described in this patent and begin the Authoring Process 1 illustrated in FIG. 2. The individual, now referred to as the original author, will draft the specific requirements for the prize 11 and when appropriate, for example assigning the intellectual property rights for the solution, choose from a set of pre-defined options. Once satisfied with the draft rules, the original author will set the duration of the review period 12. In this case, the original author may decide that two weeks is appropriate.

After the proposed prize has been submitted, subsequent visitors 112 to the site will have the ability during the two week review period 2 to edit the prize using the Review Process 3 illustrated in FIG. 3.

The original author might not have the knowledge to specify exactly when a potato chip begins to taste stale, and as a result, may have chosen to leave that section of the requirements intentionally vague. A subsequent visitor 105 to the website with knowledge of the field will have the ability during the Review Process 3 to edit the draft rules 18 and specify that a potato chip would be considered to have maintained its freshness if it had not absorbed more than 5% additional moisture after ten days in an environment with 85% humidity.

A succeeding visitor 105 might have information that a potato chip begins to taste stale after absorbing only 3% additional moisture and further edit the draft rules 18.

After the duration of the Review Process 3 has elapsed 4, any visitor 105 to the website who is not the original author of the original draft of the rules will only be able to view the most recent revision to the rules 5 using the Preview Process 6 illustrated in FIG. 4. The prize's original author 104 will be directed to the Approval Process 7 illustrated in FIG. 5.

During the Approval Process 7 the original author will have several options. If completely satisfied with the collaborative edits made to the original draft rules, the original author will choose to accept them 32 and make the prize available for funding. However, if unsatisfied, the original author will have additional recourse. The original author might feel that the challenge isn't worthwhile after all and choose to terminate the prize 9 25. The original author might also decide that the latest revision to the rules is unsuitable and make additional edits 29. For example, the original author may choose to define the acceptable moisture absorption as 4%. If the original author continues to remain dissatisfied with the rules, the option exists to extend the duration 8 35 of the Review Process 3 for further review by visitors to the website. However, if satisfied with the final edits to the rules, the original author will choose to approve them and end the Authoring Process, Review Process and Preview Process 4.

At this point users of the website will be able to read the final draft of the rules using the Presentation Process 10 illustrated in FIG. 6. Visitors to the website have the option to either contribute to the endowment of the prize 40 or submit a claim 42 if the visitor believe he or she as produced a solution to the challenge defined by the rules.

A users who agrees with the objective of the prize could chose to participate the Contribution Process 42 illustrated in FIG. 7. The visitor will enter the appropriate payment information 54, submit it to the website and have it added to the value of the prize. At this point, the specific visitor will become a contributor.

A user with a solution to the challenge, will initiate the Submission Process 43 illustrated in FIG. 8. After submitting the proof required to verify the claim 57 58, the visitor will become a claimant.

After a claim has been submitted, the Verification Process 45 illustrated in FIG. 9 will be initiated. The duration of the Verification Process 45 will be determined 59 based on a set of pre-defined conditions which could depend on the number of contributors to the prize, the value of the prize or other criteria decided upon by the operator of the website.

During the Verification Process 45, every user will be able to evaluate the claimants submission 63 and determine whether it meets the requirements stated in the rules. Contributors will then vote to either accept or reject the submission 64. If the submission garners the requisite number of votes as pre-determined by the operator of the website 67, the prize is considered solved, the prize is closed and the value of the prize awarded to the claimant 70. If the submission is rejected, the prize remains open and continues to be available for contributions.

The original author, now referred to as the administrator, will have a couple of options for administrating the prize that will not be available to other visitors to the website 47. Although the rules of a prize are fixed after the completion of the Approval Process 7, there are two instances when the administrator may modify them.

If there are two prizes with similar objectives that are reducing the effectiveness of each prize individually, the administrators of the respective prizes will have the option 48 to initiate the Merger Process 49 illustrated in FIG. 10.

For example, if there is a second prize to create bag for potato chips that will retain their freshness after being left open for eight days in an environment with 85% humidity, the two prize administrators 71 72 could choose to merger their prizes into one with a common set of rules. In this case, the administrator of the first prize, which specifies ten day, and the administrator of the second prize might conclude that specifying nine days would be a reasonable compromise.

After drafting a combined set of rules that is acceptable to the administrators of both prizes 73, the Voting Process 51 illustrated in FIG. 11 is initiated. The duration of the Voting Process 51 will be determined 74 based on a set of pre-defined conditions which could depend on the number of contributors to the prize, the value of the prize or other criteria decided upon by the operator of the website.

During the Voting Process 51, every user will be able to evaluate the rules drafted for the merger 78 and determine whether the proposal is satisfactory. Contributors will then vote to either accept of reject the merger 79. If the merger garners the requisite number of votes as pre-determined by the operator of the website 82, the two prizes are merged into one, the value of the contributions to the individual prizes combined and the merged prize made available for contributions. If the merger is rejected, the prizes remains distinct and continue to be individually available for contributions.

The second method available to the administrator for amending the rules after the completion of the Approval Process 7 is to initiate the Revision Process 53 illustrated in FIG. 12.

If during the course of administering the prize, the administrator concludes that the requirements specified by the rules are deficient, the administrator could propose a revision to the rules. For example, after significant time and considerable effort on the part of potential claimants, the administrator might conclude that requiring an opened bag of potato chips to remain fresh for any reasonable amount of time in an environment with 85% humidity is impossible. Using the Revision Process 53, the administrator will have the ability to propose a revised set of rules 88 that specifies a lower level of humidity.

The approval of revised set of rules will be determined by contributors using the Voting Process 51 described above. Every contributor will be able to evaluate the revised rules 78 to determine whether the proposal is satisfactory. Contributors will then have the option to either accept of reject the revision 79. If the merger garners the requisite number of votes as pre-determined by the operator of the website, the revision is approved. If the revision is rejected, no change is made to the rules.

Should the situation arise where the administrator has been determined to have failed to reasonably administer the prize, for example, if the administrator has failed to visit the website for an unreasonable length of time or other criteria as determined by the operator of the website, the Absentee Administrator Process illustrated in FIG. 13 will be initiated. Using criteria previously defined by the operator of the site, a prospective nominee will be selected 91 and informed of the nomination 92. If the prospective nominee declines the nomination, another prospective nominee with be selected 91 and informed 92 until the required number of nominees as determined by the operator of the website have accepted their nominations 97.

The duration of the voting period will be determined 98 based on a set of pre-defined conditions which could depend on the number of contributors to the prize, the value of the prize or other criteria decided upon by the operator of the website. The contributors will vote 103 for their preferred nominee. The vote will be tallied 107, and the winning nominee will be named as the administrator of the prize 108.

In the foregoing description, the method and apparatus of the present invention have been described with reference to specific examples. It is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative rather than in a restrictive sense.

What is claimed is:

1. A method for a rule development process for an inducement prize, the method comprising the steps of:
implementing an Authoring Process, wherein at least one rule allowing for claiming and awarding of the inducement prize is authored;
implementing a Review Process, wherein the at least one rule may be revised;
implementing a Preview Process, wherein a most recent version of the at least one rule may viewed;
implementing an Approval Process, wherein the most recent version of the at least one rule may be finalized; and
implementing a Presentation Process, wherein the finalized version of the at least one rule may be viewed.

2. The method according to claim 1, further comprising at least one of the steps of:
sending the at least one rule to a database;
storing the at least one rule in the database;
retrieving the at least one rule from the database; and
displaying the at least one rule.

3. The method according to claim 1, wherein the Authoring Process comprises at least one of the steps of:
drafting the at least one rule, wherein the at least one rule is chosen from at least one pre-defined option or created from a unique prize specific requirement; and
defining a period of time during which the Review Process may be implemented.

4. The method according to claim 1, wherein the Review Process can only be implemented during a period of time and comprises at least one of the steps of:
providing an option to edit the at least one rule; and
allowing editing of the at least one rule.

5. The method according to claim 1, wherein the Preview Process is implemented only if the at least one rule has not been finalized.

6. The method according to claim 1, wherein the Preview Process is implemented only if a user is not an original author of the at least one rule.

7. The method according to claim 1, wherein the Approval Process further comprises at least one of the steps of:
providing an option to terminate the rule development process for an inducement prize;
providing an option to accept revisions to the at least one rule;
providing an option to edit the at least one rule;
allowing editing of the at least one rule;
providing an option to extend a defined period of time during which the Review Process may be implemented;
extending the defined period of time during which the Review Process may be implemented.

8. The method according to claim 1, wherein the Approval Process is implemented only if the at least one rule has not been finalized.

9. The method according to claim 1, wherein the Approval Process is implemented only if a user is an original author of the at least one rule.

10. The method according to claim 1, wherein the Presentation Process further comprises at least one of the steps of:
providing an option to contribute to the inducement prize;
providing an option for submission of a claim for the inducement prize;
providing an option for a merger of the inducement prize with at least one other inducement prize; and
providing an option for an administrator of the inducement prize to revise the at least one rule.

11. The method according to claim 1, wherein the Presentation Process is implemented only if the at least one rule has been finalized.

12. The method according to claim 1, further comprising at least one of the steps of:
implementing a Contribution Process, wherein contributions to the inducement prize may be made;
implementing a Submission Process, wherein a claim for the inducement prize may be made;
implementing a Verification Process, wherein the claim for the inducement prize can be verified;
implementing a Merger Process, wherein the inducement prize may be merged with at least one other inducement prize;
implementing a Revision Process, wherein the finalized version of the at least one rule may revised; and
implementing a Voting Process, wherein a vote occurs for either the merger of the inducement prize with at least one other inducement prize or the revision of the finalized version of the at least one rule.

13. The method according to claim 12, wherein the Contribution Process comprises at least one of the steps of:
entering a contribution amount and payment information; and
adding a value of the contribution to a value of the inducement prize.

14. The method according to claim 12, wherein the Submission Process comprises at least one of the steps of:
entering information regarding the claimant for the inducement prize;
entering information regarding the submission for the inducement prize;
defining a period of time during which the Voting Process may be implemented;
sending a claimant's submission data to the database; and
storing the claimant's submission data in the database.

15. The method according to claim 12, wherein the Verification Process can only be implemented during a period of time and comprises at least one of the steps of:
allowing at least one user to vote as to whether to accept the claim submitted for the inducement prize;
determining whether the claim submitted for the inducement prize was approved; and
awarding the inducement prize to a claimant for the inducement prize.

16. The method according to claim 12, wherein the Merger Process can only be implemented by the administrator of the inducement prize.

17. The method according to claim 12, wherein the Merger Process comprises at least one of the steps of:
providing an option to an author of the inducement prize as to whether to merge the inducement prize with at least one other inducement prize;
jointly authoring at least one rule for the merged inducement prize and at least one other inducement prize; and
defining a period of time during which the Voting Process may be implemented.

18. The method according to claim 12, wherein the Revision Process can only be implemented by the administrator of the inducement prize.

19. The method according to claim 12, wherein the Revision Process comprises at least one of the steps of:
providing an option to edit the finalized version of at least one rule;
allowing editing of the finalized version of at least one rule; and
defining a period of time during which the Voting Process may be implemented.

20. The method according to claim 12, wherein the Voting Process can only be implemented during a period of time and comprises at least one of the steps of:
allowing at least one user to vote as to whether to accept at least one of the merger of the inducement prize with at least one other inducement prize or the revision of the finalized version of the at least one rule;
determining whether either the merger of the inducement prize with at least one other inducement prize or the revision of the finalized version of the at least one rule was accepted;
sending an accepted modification to the database; and
storing the accepted modification in the database.
